(19) United States
(12) Patent Application Publication
(10) Pub. No.: US 2018/0067927 A1
(43) Pub. Date: Mar. 8, 2018

(54) Customized Translation Comprehension

(71) Applicant: International Business Machines Corporation, Armonk, NY (US)

(72) Inventors: Venkata V. Gadepalli, Apex, NC (US); Trudy L. Hewitt, Cary, NC (US); Ashok K. Iyengar, Encinitas, CA (US); James M. Moreno, Georgetown, TX (US)

(21) Appl. No.: 15/257,109

(22) Filed: Sep. 6, 2016

(51) Int. Cl. G06F 17/28; G06F 3/0484; G06F 17/27

(52) U.S. Cl. CPC G06F 17/289; G06F 17/2785; G06F 3/04842

(57) ABSTRACT

An approach is provided that identifies an idiom in content that destined to be delivered to a recipient. The approach determines a confidence level of the recipient's understanding of the identified idiom. Based on the confidence level, the approach modifies the content accordingly, and then transmits the modified content to the recipient.

### BACKGROUND OF THE INVENTION

### Technical Field

This disclosure relates to customizing translations based on the recipient of a message. More particularly, this disclosure relates to customized idiom translations based on a recipient's knowledge of the idioms.

### Description of Related Art

Traditional translators perform exceedingly well at translating text from a source language to a target language. A difficulty, however, is that traditional translators operate literally in a word-for-word or phrase-for-phrase approach with little or no regard for idioms. As used herein, an idiom is a group of words established by a culture as having a particular meaning that is not discernable from the individual words in the phrase that constitutes the idiom. For example, in American English, the phrase “couch potato” is an idiom that refers to a person that spends little or no time exercising and too much time watching television. However, in another language, a literal translation of “couch potato” would be confusing or meaningless.

### SUMMARY

An approach is provided that identifies an idiom in content that destined to be delivered to a recipient. The approach determines a confidence level of the recipient's understanding of the identified idiom. Based on the confidence level, the approach modifies the content accordingly, and then transmits the modified content to the recipient.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a component diagram that depicts the various components used in providing customized translations involving idioms;

FIG. 4 is a depiction of a flowchart showing the general logic used to provide customized translation comprehension;

FIG. 5 is a depiction of a flowchart showing the logic used to identify possible translation issues found in content by using a natural language engine;

FIG. 6 is a depiction of a flowchart showing the logic used to identify likely translation issues by using a cognitive engine; and

FIG. 7 is a depiction of a flowchart showing the logic used to modify the original content to avoid likely translation issues and send such modified content to intended recipients.

### DETAILED DESCRIPTION

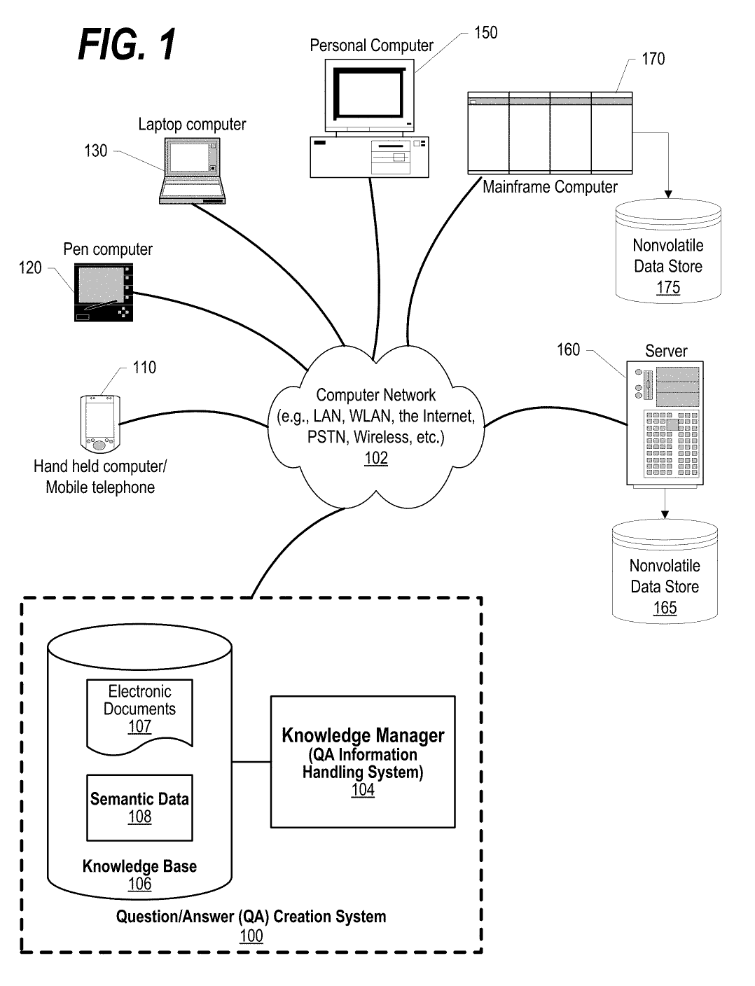

FIGS. 1-7 describe an approach that identifies an idiom in content that is destined to be delivered to a recipient. The approach determines a confidence level of the recipient's understanding of the identified idiom and, based on the determined confidence level, modifies the content accordingly before sending the content to the recipient. In one embodiment, all or part of the modified content is translated from a source language to a target language prior to being transmitted to the recipient.

In order to understand the recipient's understanding of the idiom, in one embodiment a data store is updated that reflects the recipient's exposure to the idiom. This same data store is checked with previously sent idioms being compared to the idiom found in the content to determine the recipient's knowledge of the idiom. In another embodiment, the recipient's knowledge is found by searching network accessible data stores of recipient-related knowledge of various idioms. The searching then identifies any encounters by the recipient of the idiom. In a further embodiment, the approach then calculates a confidence value based on the identified encounters by the recipient of the idiom, with this confidence values being used to determine whether to automatically modify the content with a set of alternative language that corresponds to the idiom or inserting a link in the content that is configured to display a set of alternative language that describes the idiom when the link is selected by the recipient.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts a schematic diagram of one illustrative embodiment of a question/answer creation (QA) system 100 in a computer network 102. QA system 100 may include a knowledge manager computing device 104 (comprising one or more processors and one or more memories, and potentially any other computing device elements generally known in the art including buses, storage devices, communication interfaces, and the like) that connects QA system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. QA system 100 and network 102 may enable question/answer (QA) generation functionality for one or more content users. Other embodiments of QA system 100 may be used with components, systems, sub-systems, and/or devices other than those that are depicted herein.

QA system 100 may be configured to receive inputs from various sources. For example, QA system 100 may receive input from the network 102, a corpus of electronic documents 107 or other data, a content creator, content users, and other possible sources of input. In one embodiment, some or all of the inputs to QA system 100 may be routed through the network 102. The various computing devices on the network 102 may include access points for content creators and content users. Some of the computing devices may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in electronic documents 107 for use as part of a corpus of data with QA system 100. Electronic documents 107 may include any file, text, article, or source of data for use in QA system 100. Content users may access QA system 100 via a network connection or an Internet connection to the network 102, and may input questions to QA system 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. Semantic data 108 is stored as part of the knowledge base 106. In one embodiment, the process sends well-formed questions (e.g., natural language questions, etc.) to the knowledge manager. QA system 100 may interpret the question and provide a response to the content user containing one or more answers to the question. In some embodiments, QA system 100 may provide a response to users in a ranked list of answers.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

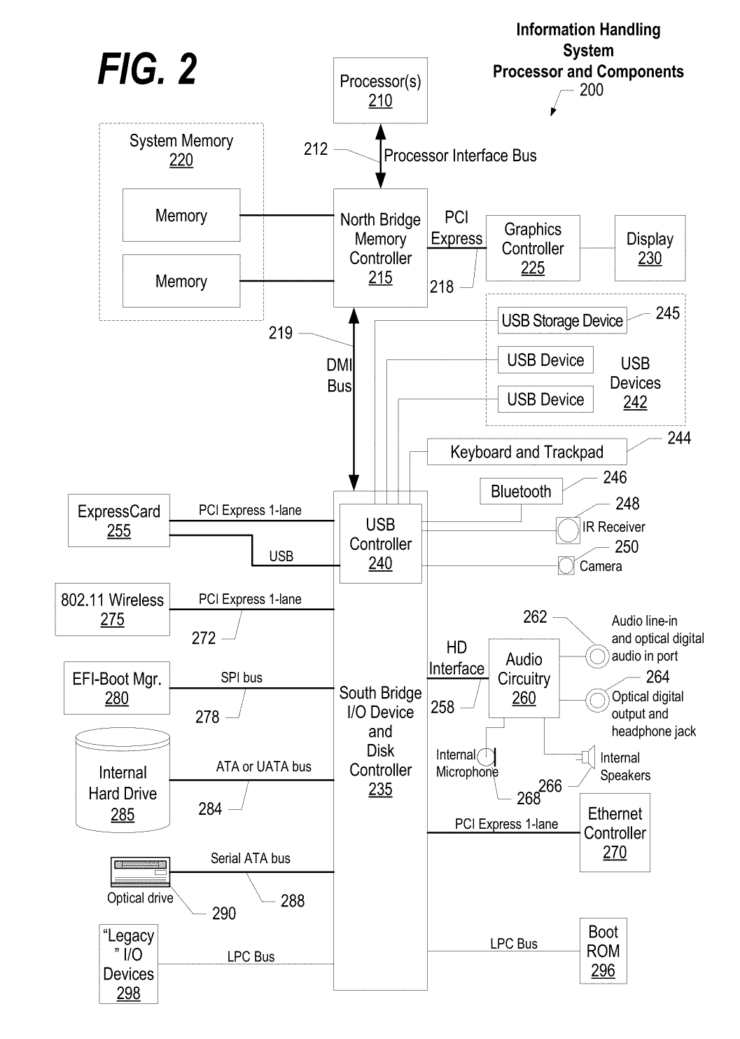

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

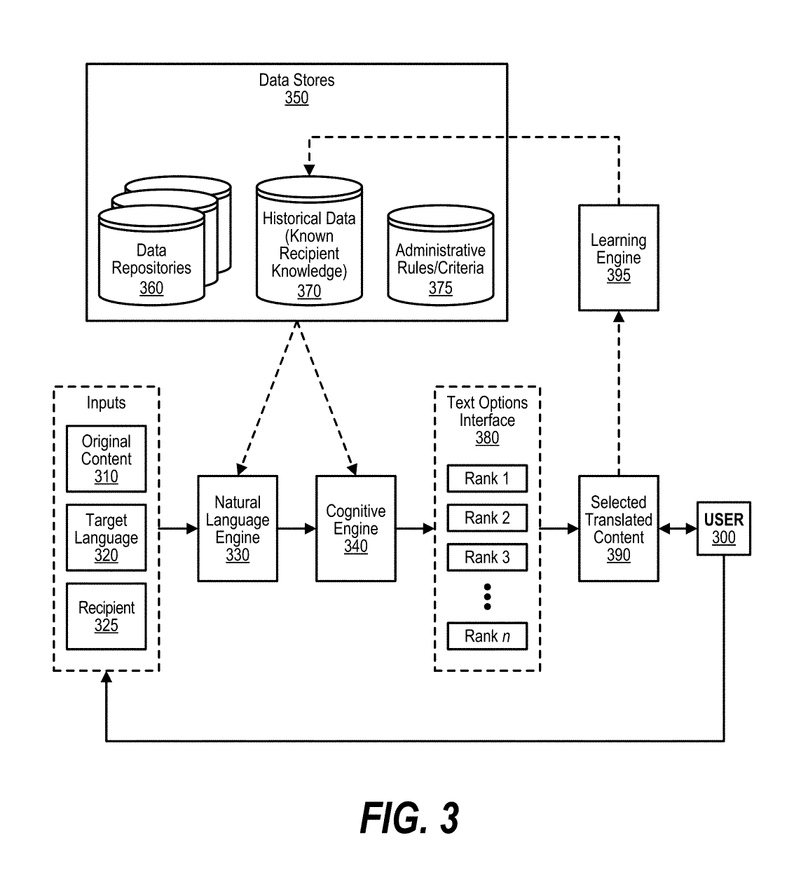

FIG. 3 is a component diagram that depicts the various components used in providing customized translations involving idioms. User 300 is depicted as the sender of original content 310 to a particular recipient 325. In one embodiment, the recipient speaks a different language, as shown by inclusion of target language 320. For example, user 300 may prepare content, such as a text or email message, in English and send to recipient 325 who speaks a different language, such as French. At step 330, the Natural Language Engine performs a process using natural language processing to identify idioms found in original content 310. The Natural Language Engine retrieves data from data stores 350 that include various data repositories 360, historical data 370, and administrative rules and criteria data 375.

At step 340, the Cognitive Engine retrieves data from data stores 350 to ascertain the recipient's knowledge of one or more idioms found in original content 310. For example, the phrase “couch potato” in English refers to a person that does not exercise and spends an inordinate amount of time watching television. However, this term, when literally translated into a target language, might be confusing or misunderstood when received by the recipient. At step 380, the Texts Options Interface alerts user 300 regarding possible translation difficulties regarding idioms found in original content 310. In one embodiment, ranks are provided to idioms that, based on the analysis performed by the Cognitive Engine, inform the user as to the likely difficulty the recipient will have understanding a particular idiom.

At step 390, the user selects translated content to include in the outgoing, or modified, content. The user might choose to leave an idiom as-is if the user receives an indication that the recipient is knowledgeable of the idiom. Likewise, the user is likely to modify the content to include the meaning of the idiom in response to receiving an indication that the recipient is unaware of the idiom. In one embodiment, the user can also include a link in the content that allows the recipient to select the link and receive a description of the idiom. At step 395, the Learning Engine updates the historical data of known recipient idiom knowledge based on the idiom data that is being transmitted to the recipient. For example, if the idiom “couch potato” is being transmitted to the recipient with an explanation of the term's meaning, then Learning Engine 395 would update data store 370 reflecting the recipient's exposure to the idiom “couch potato.”

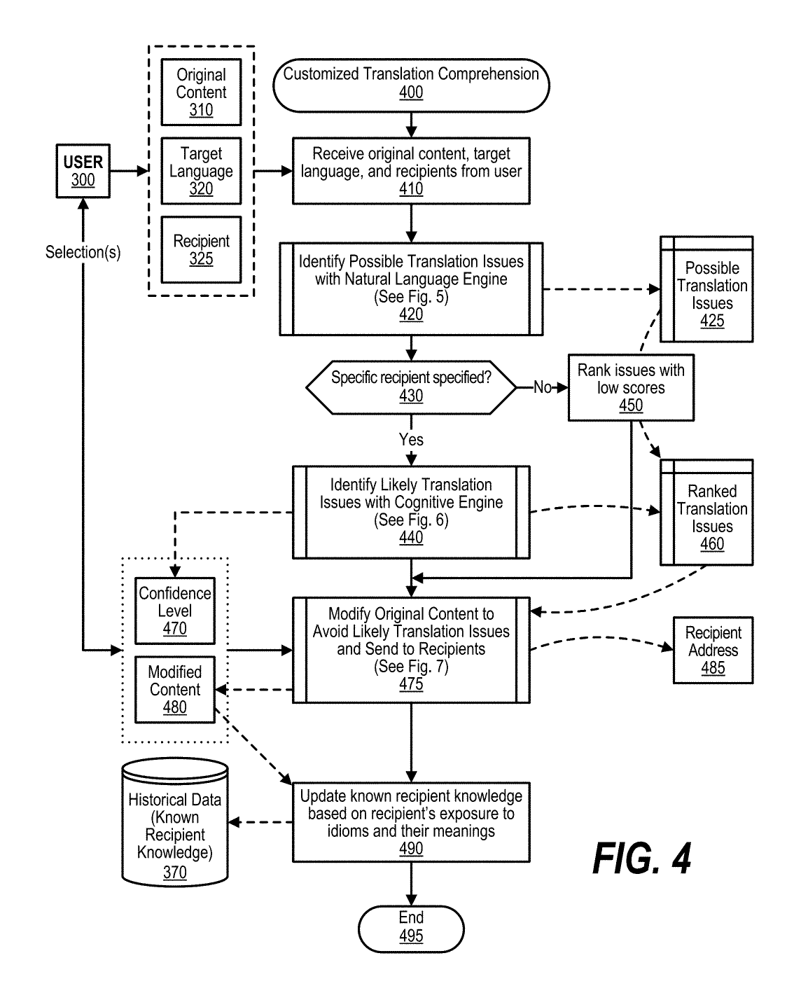

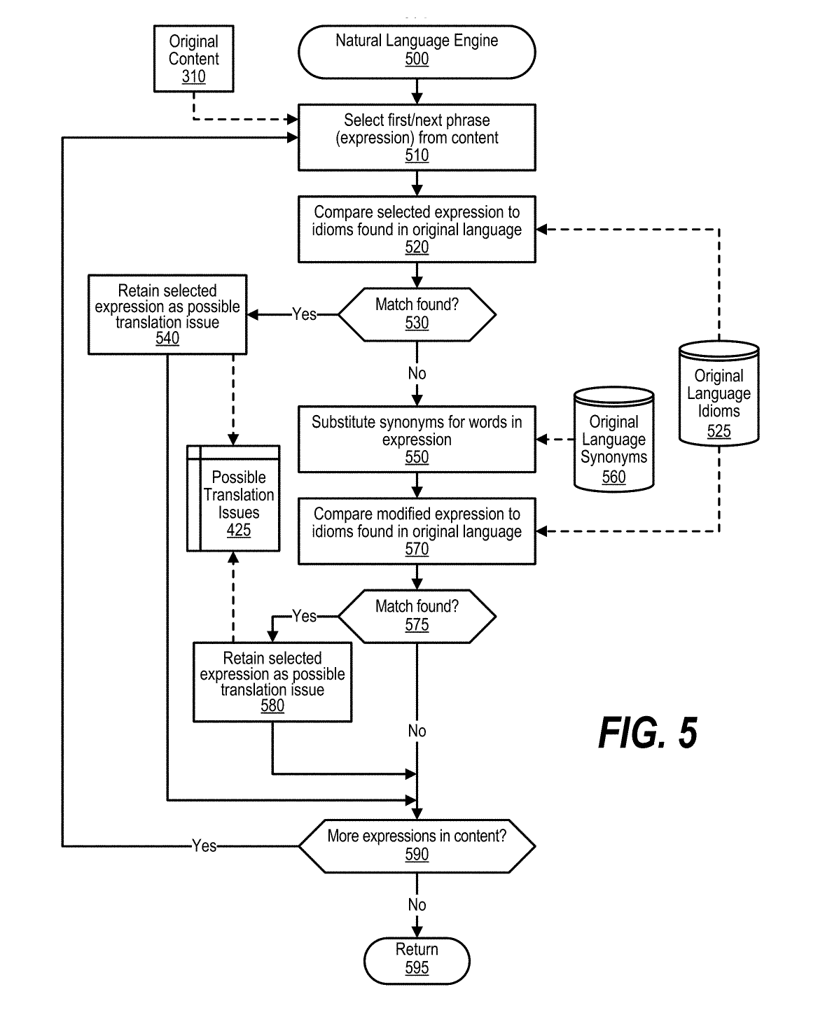

FIG. 4 is a depiction of a flowchart showing the general logic used to provide customized translation comprehension. FIG. 4 processing commences at 400 and shows the steps taken by a process that performs customized translation comprehension of content that may include language specific idioms. At step 410, the process receives original content 310, target language 320, and recipient 325 from user 300. At predefined process 420, the process performs the Identify Possible Translation Issues with Natural Language Engine routine (see FIG. 5 and corresponding text for processing details). Predefined process 420 analyzes original content 310 and identifies any possible translation issues that are stored in memory area 425. For example, if the phrase “couch potato” was found in the original content, this idiom would be stored in memory area 425 as a possible translation issue.

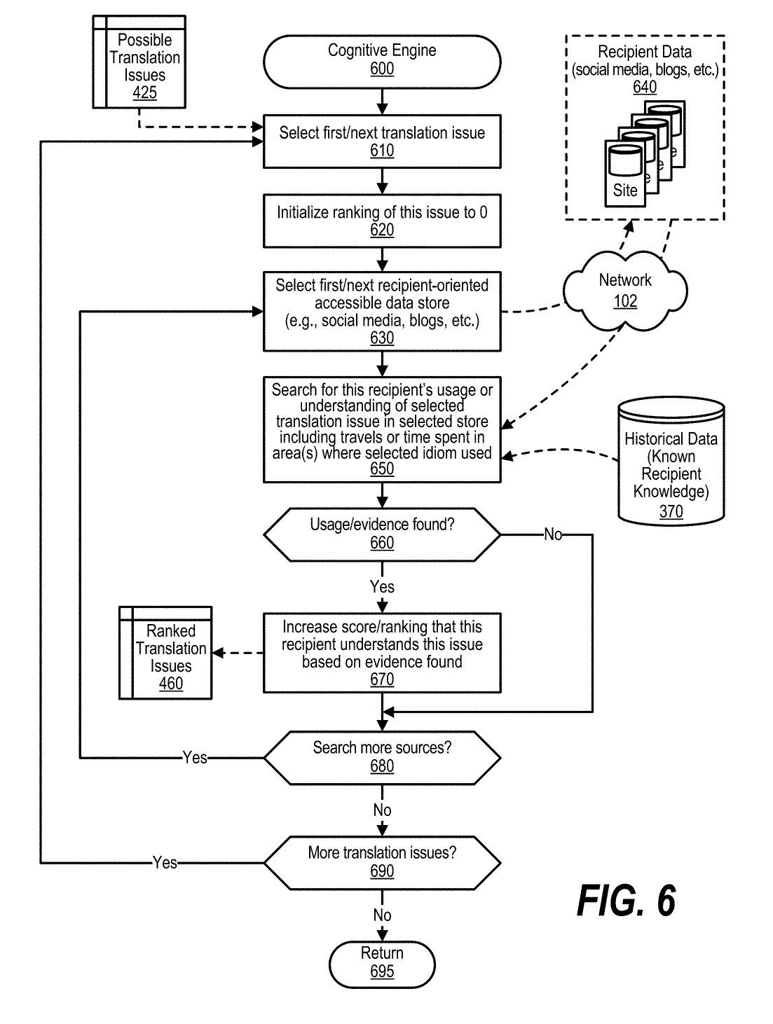

The process determines as to whether the intended recipient is a specific recipient (decision 430). If the intended recipient is a specific recipient, then decision 430 branches to the ‘yes’ branch to perform predefined process 440. On the other hand, if the intended recipient is not a specific recipient (such as no recipient specified or the recipient being a group of individual), then decision 430 branches to the ‘no’ branch to perform step 450. When a specific recipient is specified then, at predefined process 440, the process performs the Identify Likely Translation Issues with Cognitive Engine routine (see FIG. 6 and corresponding text for processing details). This routine analyzes the understanding the recipient has regarding the possible translation issues in order to score the translation issues with confidence levels with such scores stored in memory area 470. In addition, predefined process 440 ranks translation issues based on how likely such idioms are understood by the recipient. Idioms that are likely to be understood by the recipient are provided a high confidence level, while idioms that are likely to be unknown and misunderstood by the recipient are provided a low confidence level. When a specific recipient is not specified then, at step 450, the process ranks possible translation issues with low scores (low confidence levels and low ranks) indicating that such translation issues are very likely to be problematic because the system is unable to analyze the knowledge of any specific recipients with regard to the idioms found in the content.

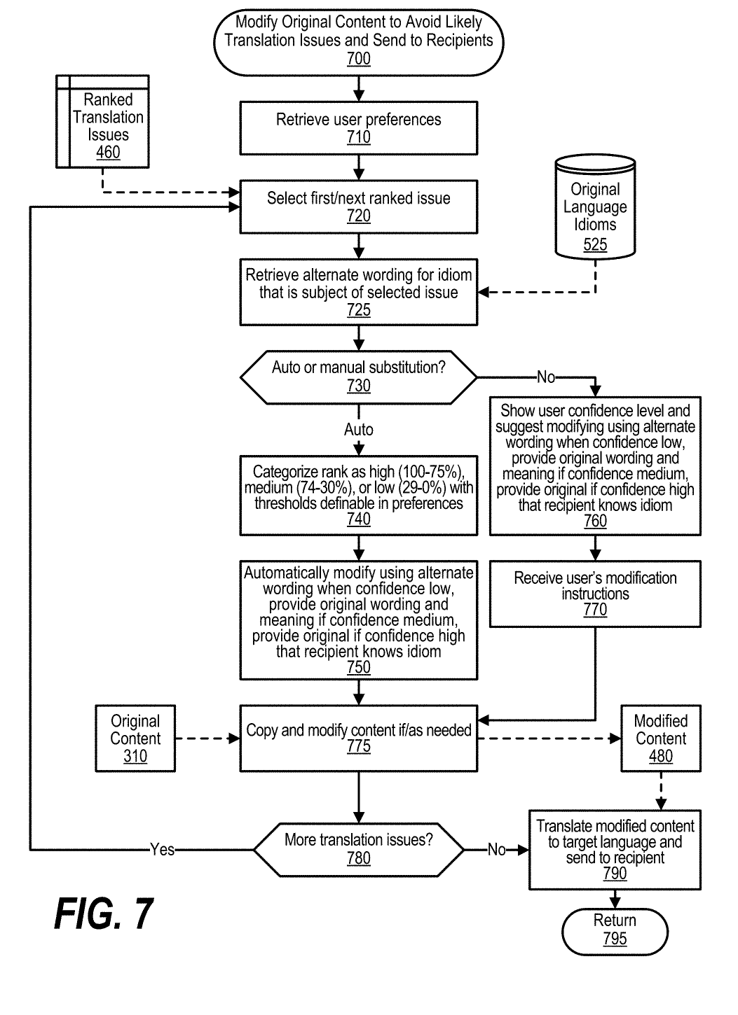

At predefined process 475, the process performs the Modify Original Content to Avoid Likely Translation Issues and Send to Recipients routine (see FIG. 7 and corresponding text for processing details). This routine modifies original content based on the confidence levels of the ranked translation issues. For example, if two idioms were found in the original content, “couch potato” and “raining cats and dogs,” and predefined process 440 determined that the recipient had sufficient knowledge of the “raining cats and dogs” idiom, but that the recipient had no knowledge of the “couch potato” idiom, then the original content might be modified to provide alternative wording for the “couch potato” idiom, but leave the “raining cats and dogs” idiom intact. The modified content is then stored in memory area 480 and such modified content is then transmitted to recipient address 485, such as an email address, that corresponds to the recipient.

At step 490, the process updates the known recipient's knowledge based on recipient's exposure to idioms and their meanings from the modified content that was sent to the recipient in predefined process 475. In one embodiment, an idiom can be provided to the recipient along with the alternative meaning of the idiom so that the recipient can learn what the idiom means. For example, the modified content might include the idiom “couch potato” along with a meaning that explains that a “couch potato” refers to a person that does not exercise and watches an inordinate amount of television. The historical data pertaining to the recipient's knowledge of idioms is stored in data store 370. FIG. 4 processing thereafter ends at 495.

FIG. 5 is a depiction of a flowchart showing the logic used to identify possible translation issues found in content by using a natural language engine. FIG. 5 processing commences at 500 and shows the steps taken the Natural Language Engine that identifies idioms within content. At step 510, the process selects the first phrase (expression) from original content 310. At step 520, the process compares the selected expression to idioms found in original (source) language. The source language idioms used for comparisons are retrieved from data store 525. The process determines as to whether the selected expression matches an idiom (decision 530). If the selected expression matches an idiom, then decision 530 branches to the ‘yes’ branch to perform step 540. When the selected expression matches an idiom then, at step 540, the process retains the selected expression (idiom) as a possible translation issue. The possible translation issues are stored in memory area 425.

On the other hand, if the selected expression does not exactly match an idiom, then decision 530 branches to the ‘no’ branch to perform substitute word checking. When the selected expression does not exactly match an idiom then, steps 550 and 560 are used to perform substitute idiom word checking. At step 550, the process substitutes synonyms for words in the original expression. For example, instead of using the idiom “couch potato,” perhaps the original content refers to an individual as a “couch spud” with “spud” being a synonym for “potato.” At step 570, the process compares the modified expression to idioms found in original language. The process determines as to whether the modified expression matches an idiom (decision 575). If the modified expression matches an idiom, then decision 575 branches to the ‘yes’ branch to perform step 580. On the other hand, if the modified expression does not match an idiom, then decision 575 branches to the ‘no’ branch bypassing step 580. At step 580, the process retains the selected expression as a possible translation issue by storing the expression in memory area 425. Steps 550 through 580 can be repeated any number of times based on the number of synonyms available for the words used in the original expression.

The process determines as to whether there are more expressions in the original content to process (decision 590). If there are more expressions in the original content to process, then decision 590 branches to the ‘yes’ branch which loops back to step 510 to select and process the next expression from the original content. This looping continues until there are no more expressions in the original content to process, at which point decision 590 branches to the ‘no’ branch exiting the loop. FIG. 5 processing thereafter returns to the calling routine (see FIG. 4) at 595.

FIG. 6 is a depiction of a flowchart showing the logic used to identify likely translation issues by using a cognitive engine. FIG. 6 processing commences at 600 and shows the steps taken by the Cognitive Engine routine that determines the recipient's understanding of idioms found in the original content. At step 610, the process selects the first translation issue from the list of possible translation issues that were previously found and stored in memory area 425. At step 620, the process initializes the ranking of this possible translation issue to zero indicating that the process currently has not discovered any references that indicate that the recipient has any knowledge of the selected translation issue.

At step 630, the process selects the first recipient-oriented accessible data store from one or more recipient data stores 640. These data stores can include social media sites used by the recipient, blogs written by the recipient, forum or other post entries, such as in email or text messages, written or received by the recipient, and the like. At step 650, the process searches for this recipient's usage or understanding of selected translation issue in the selected data store. In one embodiment, the search also includes travels references or time spent in areas or locations where selected the idiom is known to be used. In addition, one of the data stores searched in this step is historical data pertaining to known recipient knowledge of the idiom (retrieved from data store 370), with the known recipient knowledge being updated when this system sends the recipient content that exposes the recipient to particular idioms.

The process determines as to whether the search discovered any usage or other evidence that the recipient has knowledge of the selected idiom (decision 660). If the search discovered any usage or other evidence that the recipient has knowledge of the selected idiom, then decision 660 branches to the ‘yes’ branch whereupon, at step 670, the process increases the confidence score and/or ranking indicating this recipient's level of understanding of this idiom based on the evidence that was found. The increased score pertaining to the selected idiom is stored in memory area 460. Returning to decision 550, if the search failed to discover any usage or other evidence that the recipient has knowledge of the selected idiom, then decision 660 branches to the ‘no’ branch bypassing step 670.

The process determines as to whether there are more data stores to search for the recipient's knowledge of the selected idiom (decision 680). If there are more data stores to search for the recipient's knowledge of the selected idiom, then decision 680 branches to the ‘yes’ branch which loops back to step 630 to search the next data store. This looping continues until there are no more data stores to search, at which point decision 680 branches to the ‘no’ branch exiting the loop. The process determines as to whether more translation issues (idioms) that were found by the preceding process that need to be analyzed (decision 690). If there are more idioms to process, then decision 690 branches to the ‘yes’ branch which loops back to step 610 to select and process the next idiom as described above. This looping continues until there are no more idioms to process, at which point decision 690 branches to the ‘no’ branch exiting the loop. FIG. 6 processing thereafter returns to the calling routine (see FIG. 4) at 695.

FIG. 7 is a depiction of a flowchart showing the logic used to modify the original content to avoid likely translation issues and send such modified content to intended recipients. FIG. 7 processing commences at 700 and shows the steps taken by a process that modifies the original content in order to avoid likely translation issues that may be present due to idioms and sends the modified content to the recipient. At step 710, the process retrieves user preferences from a data store. At step 720, the process selects the first ranked translation issue from memory area 460. Using the example previously introduced, if the original content included two idioms one saying it was “raining cats and dogs” and another saying that the sender's son was a “couch potato,” memory area 460 would include these idioms along with the confidence level that the recipient understands each of the idioms. For example, the process performed in FIG. 6 may have determined that the recipient's confidence level of understanding that it was “raining cats and dogs” was relatively high (e.g., eighty percent, etc.), while the recipient's confidence level of understanding the idiom “couch potato” was relatively low (e.g., ten percent, etc.). In this example, it would be relatively safe to present the “raining cats and dogs” idiom to the recipient as there is a high likelihood that the recipient understands this idiom, however, the idiom “couch potato” may necessitate modification to the content in order to explain the meaning being conveyed by the sender.

At step 725, the process retrieves alternate wording for idiom that is subject of selected issue from data store 525. Using the examples from above, alternate wording for “raining cats and dogs” might be “raining quite heavily,” and alternate wording for “couch potato” might be “lazy television watcher.” The process determines as to whether the user (the sender) has a preference of automatic or manual substitution (decision 730). If the user prefers automatic substitution, then decision 730 branches to the “Auto” branch and performs steps 740 and 750. On the other hand, if the user prefers manual substitution, then decision 730 branches to the “Manual” branch and performs steps 760 and 770. When the user prefers automatic substitution, then steps 740 and 750 are performed. At step 740, the process categorizes the rank as high (e.g., 100-75%, etc.), medium (e.g., 74-30%, etc), or low (e.g., 29-0%, etc.) with these thresholds also being definable in the user preferences. At step 750, the process automatically modifies the original content using the alternate wording when the confidence level is low, provide both the original wording and the alternate wording (meaning) if the confidence is in the middle category, and provides the original content if the confidence level is high that recipient knows the selected idiom.

When the user prefers manual substitution, then steps 760 and 770 are performed. At step 760, the process shows the user the confidence level of the idiom and suggests modifying using alternate wording when confidence low, provides original wording and meaning if confidence is medium, and suggests using the original content if the confidence level is high that recipient knows the selected idiom. At step 770, the process receives the user's modification instructions regarding the selected idiom and any alternate language to include in the modified content. At step 775, the process copies and modifies the original content from memory area 310 if and as needed with the modified content being stored in memory area 480.

The process determines as to whether there are more translation issues (idioms) to process (decision 780). If there are more idioms to process, then decision 780 branches to the ‘yes’ branch which loops back to step 720 to select and process the next idiom as described above. This looping continues until all of the idioms have been processed, at which point decision 780 branches to the ‘no’ branch exiting the loop. At step 790, in one embodiment, the process translates the modified content from the source language to the target language. The modified content is sent to the recipient (e.g., email message, text message, etc.). FIG. 7 processing thereafter returns to the calling routine (see FIG. 4) at 795.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method implemented by an information handling system that includes a processor and a memory accessible by the processor, the method comprising:
identifying an idiom in content destined to a recipient;
searching one or more network accessible data stores of recipient-related knowledge, wherein at least one of the data stores is inaccessible by a sender of the content;
identifying, as a result of the searching, zero or more encounters by the recipient of the idiom;
based on the identifying, determining a confidence level of the recipient's understanding of the identified idiom;
modifying the content based on the determined confidence level; and
transmitting the modified content to the recipient.

2. The method of claim 1 further comprising:
translating all or part of the modified content from a source language to a target language prior to the transmitting.

3. The method of claim 1 further comprising:
updating a data store reflecting the recipient's exposure to the idiom, wherein the determining includes retrieving one or more previously sent idioms from the data store and comparing the previously sent idioms to the idiom.

4. (canceled)

5. The method of claim 1 further comprising:
calculating a confidence value based on the identified encounters by the recipient of the idiom; and
automatically modifying the content with a set of alternative language that corresponds to the idiom in response to the confidence value indicating that the recipient has low knowledge of the idiom.

6. The method of claim 1 further comprising:
calculating a confidence value based on the identified encounters by the recipient of the idiom; and
inhibiting the modification of the content in response to the confidence value indicating that the recipient has knowledge of the idiom.

7. The method of claim 6 further comprising:
inserting a link in the content that is configured to display a set of alternative language that describes the idiom when the link is selected by the recipient.

8. An information handling system comprising:
one or more processors;
a memory coupled to at least one of the processors; and
a set of computer program instructions stored in the memory and executed by at least one of the processors in order to perform actions comprising:
identifying an idiom in content destined to a recipient;
searching one or more network accessible data stores of recipient-related knowledge, wherein at least one of the data stores is inaccessible by a sender of the content;
identifying, as a result of the searching, zero or more encounters by the recipient of the idiom;
based on the identifying, determining a confidence level of the recipient's understanding of the identified idiom;
modifying the content based on the determined confidence level; and
transmitting the modified content to the recipient.

9. The information handling system of claim 8 wherein the actions further comprise:
translating all or part of the modified content from a source language to a target language prior to the transmitting.

10. The information handling system of claim 8 wherein the actions further comprise:
updating a data store reflecting the recipient's exposure to the idiom, wherein the determining includes retrieving one or more previously sent idioms from the data store and comparing the previously sent idioms to the idiom.

11. (canceled)

12. The information handling system of claim 8 wherein the actions further comprise:
calculating a confidence value based on the identified encounters by the recipient of the idiom; and
automatically modifying the content with a set of alternative language that corresponds to the idiom in response to the confidence value indicating that the recipient has low knowledge of the idiom.

13. The information handling system of claim 8 wherein the actions further comprise:
calculating a confidence value based on the identified encounters by the recipient of the idiom; and
inhibiting the modification of the content in response to the confidence value indicating that the recipient has knowledge of the idiom.

14. The information handling system of claim 13 wherein the actions further comprise:
inserting a link in the content that is configured to display a set of alternative language that describes the idiom when the link is selected by the recipient.

15. A computer program product stored in a computer readable storage medium, comprising computer program code that, when executed by an information handling system, performs actions comprising:
identifying an idiom in content destined to a recipient;
searching one or more network accessible data stores of recipient-related knowledge, wherein at least one of the data stores is inaccessible by a sender of the content;
identifying, as a result of the searching, zero or more encounters by the recipient of the idiom;
based on the identifying, determining a confidence level of the recipient's understanding of the identified idiom;
modifying the content based on the determined confidence level; and
transmitting the modified content to the recipient.

16. The computer program product of claim 15 wherein the actions further comprise:
translating all or part of the modified content from a source language to a target language prior to the transmitting.

17. The computer program product of claim 15 wherein the actions further comprise:
updating a data store reflecting the recipient's exposure to the idiom, wherein the determining includes retrieving one or more previously sent idioms from the data store and comparing the previously sent idioms to the idiom.

18. (canceled)

19. The computer program product of claim 15 wherein the actions further comprise:
calculating a confidence value based on the identified encounters by the recipient of the idiom; and
automatically modifying the content with a set of alternative language that corresponds to the idiom in response to the confidence value indicating that the recipient has low knowledge of the idiom.

20. The computer program product of claim 15 wherein the actions further comprise:
calculating a confidence value based on the identified encounters by the recipient of the idiom; and
inhibiting the modification of the content in response to the confidence value indicating that the recipient has knowledge of the idiom.
